(19) United States
(12) Patent Application Publication
(10) Pub. No.: US 2013/0238835 A1
(43) Pub. Date: Sep. 12, 2013

(54) BURNING SYSTEM AND METHOD

(71) Applicants: HUA-LIN LIU, Shenzhen City (CN); ZHI-FENG WANG, Shenzhen City (CN); XIN LU, Shenzhen City (CN); SHIH-FANG WONG, Tu-Cheng (TW)

(72) Inventors: HUA-LIN LIU, Shenzhen City (CN); ZHI-FENG WANG, Shenzhen City (CN); XIN LU, Shenzhen City (CN); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/447,298

(22) Filed: Apr. 16, 2012

(30) Foreign Application Priority Data
Mar. 6, 2012 (CN) 201210056477.2

(51) Int. Cl. G06F 12/00

(52) U.S. Cl. 711/103; 711/E12.008

(57) ABSTRACT

A burning system includes an indentifying module, a dividing module, a calculating module, an index module, and a burning module. The identifying module identifies bad blocks of the flash memory. The dividing module reads all blocks of the flash memory in sequence, and when one or more continuous blocks being read are bad blocks, groups the bad blocks and the previously read good block as a storage sector. The calculating module calculates a bad block ratio of each storage sector. The index module assigns a priority level to each storage sector according to the bad block ratio of the storage sector, and associates each priority level of the storage sectors with a start address. The burning module accesses the storage sectors in an order of the priority levels of the storage sectors, and begins writing programs into the storage sectors from the associated start addresses.

### BACKGROUND

1. Technical Field

The present disclosure relates to burning systems and, more particularly, to a burning system for burning at least one program to a flash memory and a burning method adapted for the burning system.

2. Description of Related Art

Many solid-state storage units, such as NAND flash memories, include a number of storage blocks arranged in a matrix. During burning data to or erasing data from the storage blocks, it is needed to check whether the data is correctly burnt to or erased from each storage block. If an error occurs in one storage block, the storage block is determined to be a bad block and is marked. The marked bad blocks will not be used to burn data later on.

However, the bad blocks are often randomly distributed in the solid-state storage. The data may be written to some areas having greater number of bad blocks, so increasing the time for writing the data into the solid-state storage.

Therefore, what is needed is a means to solve the problem described above.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a burning system, in accordance with an exemplary embodiment.

FIG. 2 is a schematic view of a NAND flash memory for use in the burning system of FIG. 1.

FIG. 3 is a flowchart of a burning method, in accordance with an exemplary embodiment.

FIG. 4 is a flowchart of a burning method, in accordance with an alternative embodiment.

### DETAILED DESCRIPTION

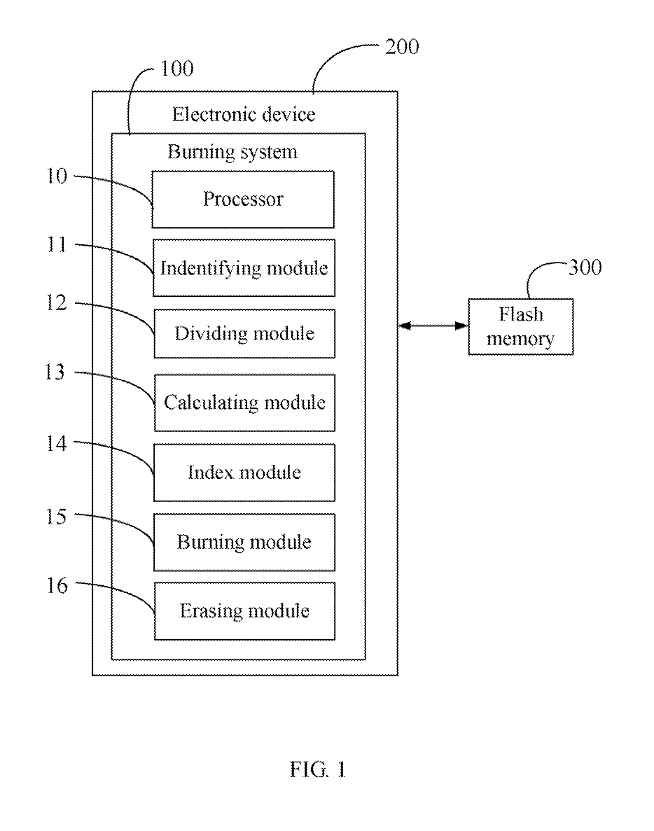

FIG. 1 is a block diagram of a burning system 100 according to an exemplary embodiment. The burning system 100 is configured for writing one or more programs to a flash memory 300, and includes a processor 10 and a variety of modules executed by the processor 10 to provide the functions of the burning system 100. In the embodiment, the burning system 100 is applied to an electronic device 200. The flash memory 300 is a NAND flash which includes a number of physical storage blocks, and for the convenience of description, these physical storage blocks will be referred as blocks thereinafter.

In the embodiment, the burning system 100 includes an identifying module 11, a dividing module 12, a calculating module 13, an index module 14, and a burning module 15.

The identifying module 11 identifies bad blocks of the flash memory 300. Data in the flash memory 300 are erased in units of blocks. Each block is divided into a number of pages, and each page is served as the smallest writing and reading unit. Each page is formed by a number of bits valued of 0 and 1. If one block includes at least one bit valued of 0 after an erasing operation is executed on the block, the data in the block cannot be completely erased and the block is identified as a bad block; otherwise, if one block includes no bit valued of 0 after an erasing operation is executed on the block, the data in the block are completely erased and the block is identified as a good block. Thereby, in the embodiment, the burning system 100 further includes an erasing module 16. Before the identifying module 11 identifies the bad blocks, the erasing module 16 erases data in all the blocks of the flash memory 300. The identifying module 11 identifies the block in which the data are not completely erased as a bad block. However, one of skill in the art will recognize other ways to determine whether a block is a bad block no longer suitable for storing the programs.

The dividing module 12 reads all blocks of the flash memory 300 in sequence, when one or more continuous blocks being read are bad blocks, the dividing module 12 groups the bad blocks and the previously read good blocks as a storage sector, and divides the flash memory 300 into at least one storage sector. In the embodiment, if a number of consecutive bad blocks are read, the dividing module 12 groups the consecutive bad blocks and the previous read blocks as a storage sector. The continuous blocks are blocks of the flash memory 300 that have sequential logical addresses.

The calculating module 13 calculates a bad block ratio of each storage sector based on the number of bad blocks with respect to the number of all the blocks of the storage sector.

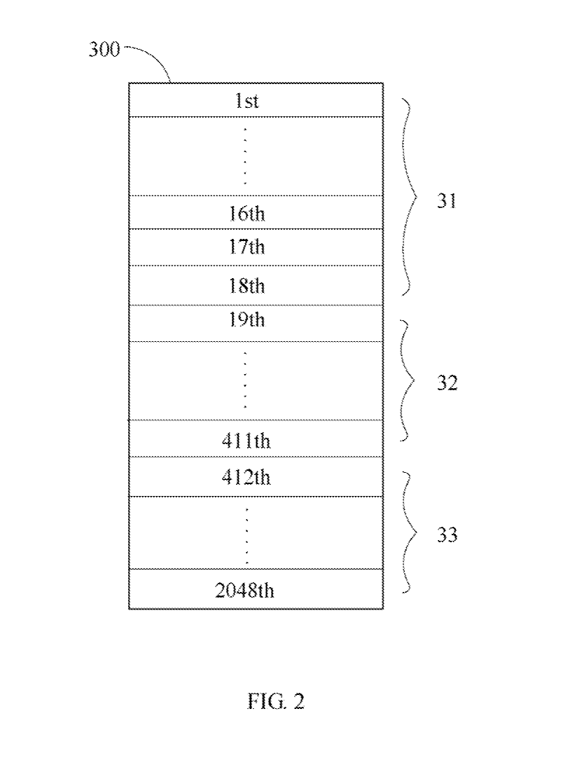

FIG. 2 shows a NAND flash memory with a storage capacity of 2 GB equivalent to 2048 blocks as an example. If the 16th block, the 17th block, the 18th block and the 411th block are identified as the bad blocks, the dividing module 12 divides the NAND flash memory into three storage sectors, namely a first storage sector 31, a second storage sector 32, and a third storage sector 33. The first storage sector 31 is formed from 1st block to 18th block, the second storage sector 32 is formed from 19th block to 411th block, and the third storage sector 33 is formed from 412th block to 2048th block. The bad block ratio of the first storage sector 31 is calculated to be 3/18, the bad block ratio of the second storage sector 32 is calculated to be 1/(411−19+1), and the bad block ratio of the third storage sector 33 is calculated to be 0/(2048−412+1).

The index module 14 assigns a priority level to each storage sector according to the bad block ratio of the storage sector, and associates each priority level of the storage sectors with a start address indicating a start location for writing the programs into the storage sector. In the embodiment, the priority level of a storage sector with a lower bad block ratio is higher than that of a storage sector with a higher bad block ratio. According to the example mentioned above, the third storage sector 33 has a highest priority level, and the first storage sector 31 has a lowest priority level.

In the embodiment, the start address of each storage sector is the logical address linked to the first block in the storage sector. For example, the start address of the second storage sector 32 is the logical address of the 19th block, and the start address of the third storage sector 33 is the logical address of the 412th block.

The burning module 15 accesses the storage sectors in an order of the priority levels of the storage sectors from high to low, and then begins writing the programs into the storage sectors from the associated start addresses of the storage sectors.

In an alternative embodiment, after the bad blocks of the flash memory 300 are identified, the identifying module 11 further compares the program's size with the remaining storage capacity of the flash memory 300. The remaining storage capacity of the flash memory 300 is the difference between the storage capacity of the flash memory 300 and the total capacity of all the bad blocks. When the program's size is determined to be less than the remaining storage capacity of the flash memory 300, the dividing module 12 divides the flash memory 300 into at least one storage sector. When the program's size equals to or is greater than the remaining storage capacity of the flash memory 300, the dividing module 12 does not divide the flash memory 300 into at least one storage sector. Furthermore, when the flash memory 300 is divided into more than one storage sector, the calculating module 13 calculates the bad block ratio of each storage sector. When the flash memory 300 only includes one storage sector, the calculating module 13 does not calculate the bad block ratio. In this case, the burning module 15 begins writing the programs into the flash memory 300 from the address linked to the first block of the flash memory 300.

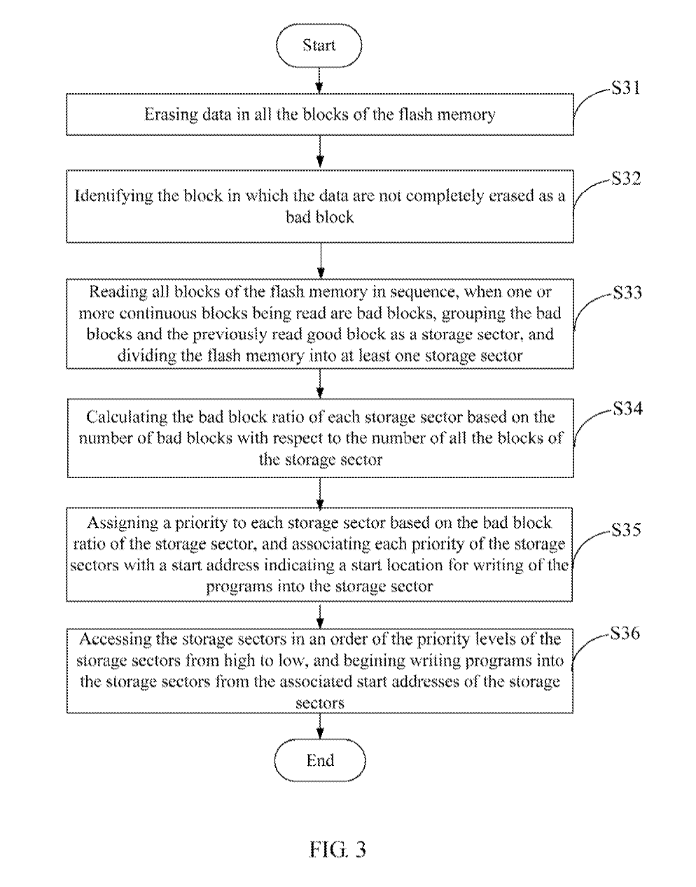

FIG. 3 is a flowchart of a burning method implemented by the burning system 100 of FIG. 1 according to an exemplary embodiment.

In step S31, the erasing module 16 erases data in all the blocks of the flash memory 300.

In step S32, the identifying module 11 identifies the block in which the data are not completely erased as a bad block.

In step S33, the dividing module 12 reads all blocks of the flash memory 300 in sequence, when one or more continuous blocks being read are bad blocks, the dividing module 12 groups the bad blocks and the previously read good block as a storage sector, and dividing the flash memory 300 into at least one storage sector.

In step S34, the calculating module 13 calculates the bad block ratio of each storage sector based on the number of bad blocks with respect to the number of all the blocks of the storage sector.

In step S35, the index module 14 assigns a priority level to each storage sector according to the bad block ratio of the storage sector, and associates each priority level of the storage sectors with a start address indicating a start location for writing the programs into the storage sector.

In step S36, the burning module 15 accesses the storage sectors in an order of the priority levels of the storage sectors from high to low, and then begins writing programs into the storage sectors from the associated start addresses of the storage sectors.

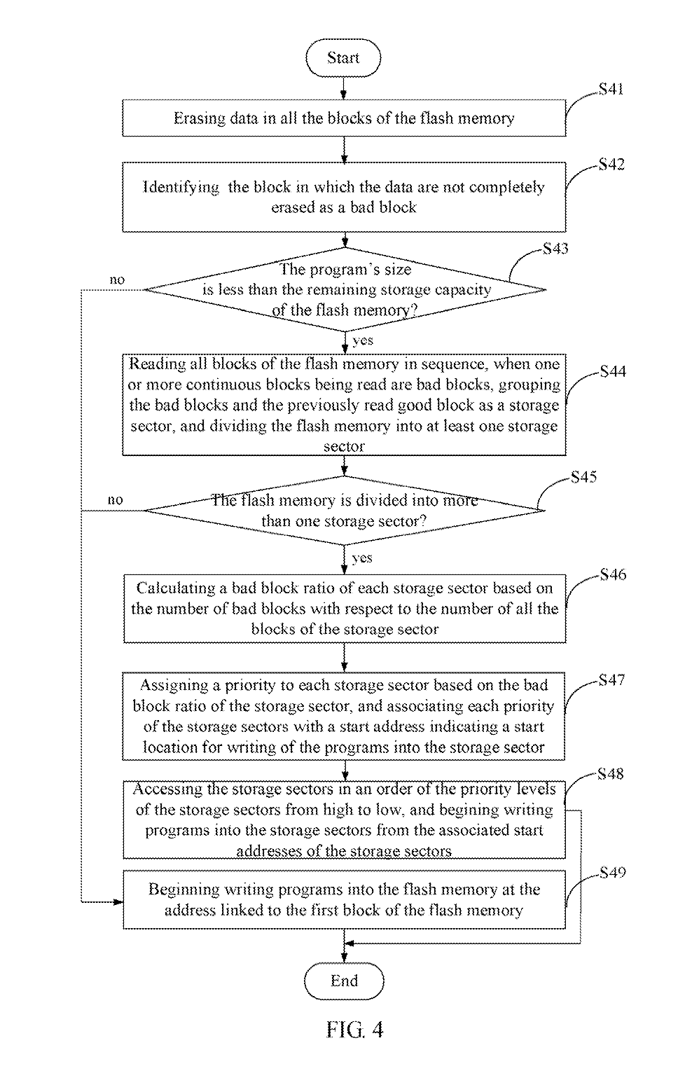

FIG. 4 is a flowchart of a burning method implemented by the burning system 100 of FIG. 1 according to an alternative embodiment.

In step S41, the erasing module 16 erases data in all the blocks of the flash memory 300.

In step S42, the identifying module 11 identifies the block in which the data are not completely erased as a bad block.

In step S43, the identifying module 11 compares the program's size with the remaining storage capacity of the flash memory 300, if the program's size is less than the remaining storage capacity of the flash memory 300, the procedure goes to step S44; otherwise, the procedure goes to step S49.

In step S44, the dividing module 12 reads all blocks of the flash memory 300 in sequence, when one or more continuous blocks being read are bad blocks, the dividing module 12 groups the bad blocks and the previously read good block as a storage sector, and dividing the flash memory 300 into at least one storage sector.

In step S45, the calculating module 13 determines whether the flash memory 300 is divided into more than one storage sector, if yes, the procedure goes to step S46; otherwise, the procedure goes to step S49.

In step S46, the calculating module 13 calculates the bad block ratio of each storage sector based on the number of bad blocks with respect to the number of all the blocks of the storage sector.

In step S47, the index module 14 assigns a priority level to each storage sector according to the bad block ratio of the storage sector, and associates each priority level of the corresponding storage sector with a start address indicating a start location for writing the programs into the storage sector.

In step S48, the burning module 15 accesses the storage sectors in an order of the priority levels of the storage sectors from high to low, and then begins writing programs into the storage sectors from the associated start addresses of the storage sectors.

In step S49, the burning module 15 begins writing programs into the flash memory 300 from the address linked to the first block of the flash memory 300.

Although the present disclosure has been described in accordance with the embodiments shown, one of ordinary skill in the art will readily recognize that there could be variations to the embodiments and those variations would be within the spirit and scope of the present disclosure. Accordingly, many modifications may be made by one of ordinary skill in the art without departing from the spirit and scope of the appended claims.

What is claimed is:

1. A burning system configured for writing at least one program into a flash memory, the burning system comprising a processor and a plurality of modules executed by the processor, the plurality of modules comprising:
an identifying module to identify bad blocks of the flash memory;
a dividing module to read all blocks of the flash memory in sequence, and when one or more continuous blocks being read are bad blocks, group the bad blocks and the previously read good block as a storage sector, and divide the flash memory into at least one storage sector;
a calculating module to calculate a bad block ratio of each storage sector based on the number of bad blocks with respect to the number of all the blocks of the storage sector;
an index module to assign a priority level to each storage sector according to the bad block ratio of the storage sector, and associate each priority level of the storage sectors with a start address indicating a start location for writing the programs into the storage sector, wherein the priority level of a storage sector with a lower bad block ratio is higher than that of a storage sector with a higher bad block ratio; and
a burning module to access the storage sectors in an order of the priority levels of the storage sectors from high to low, and begin writing programs into the storage sectors from the associated start addresses of the storage sectors.

2. The burning system as described in claim 1, further comprising an erasing module, wherein the erasing module erases data in all the blocks of the flash memory, and the identifying module identifies a block in which the data are not completely erased as a bad block.

3. The burning system as described in claim 1, wherein the start address of each storage sector is the logical address linked to the first block in the storage sector.

4. A burning method for writing at least one program to a flash memory, comprising:
identifying bad blocks of the flash memory;
reading all blocks of the flash memory in sequence, and when one or more continuous blocks being read are bad blocks, grouping the bad blocks and the previously read good blocks as a storage sector, and dividing the flash memory into at least one storage sector;
calculating a bad block ratio of each storage sector based on the number of bad blocks with respect to the number of all the blocks of the storage sector;
assigning a priority level to each storage sector according to the bad block ratio of the storage sector, and associating each priority level of the storage sectors with a start address indicating a start location for writing the programs into the storage sector, wherein the priority level of a storage sector with a lower bad block ratio is higher than that of a storage sector with a higher bad block ratio; and
accessing the storage sectors in an order of the priority levels of the storage sectors from high to low, and beginning writing programs into the storage sectors from the associated start addresses of the storage sectors.

5. The burning method as described in claim 4, wherein the step “identifying bad blocks of the flash memory” comprise:
erasing data in all the blocks of the flash memory; and
identifying a block in which the data are not completely erased as a bad block.

6. The burning method as described in claim 5, wherein the start address of each storage sector is the logical address linked to the first block in the storage sector.

7. A burning system configured for writing at least one program into a flash memory, the burning system comprising a processor and a plurality of modules executed by the processor, the plurality of modules comprising:
an identifying module to identify bad blocks of the flash memory;
a dividing module to read all blocks of the flash memory in sequence when the program's size is determined to be less than the remaining storage capacity of the flash memory, and when one or more continuous blocks being read are bad blocks, group the bad blocks and the previously read good blocks as a storage sector, and divide the flash memory into at least one storage sector;
a calculating module to calculate a bad block ratio of each storage sector based on the number of the bad blocks with respect to the number of all the blocks of the storage sector when the flash memory is divided into more than one storage sector;
an index module to assign a priority level to each storage sector according to the bad block ratio of the storage sector, and associate each priority level of the storage sectors with a start address indicating a start location for writing the programs into the storage sector, wherein the priority level of a storage sector with a lower bad block ratio is higher than that of a storage sector with a higher bad block ratio; and
a burning module to access the storage sectors in an order of the priority levels of the storage sectors from high to low, and begin writing programs into the storage sectors from the associated start addresses of the storage sectors.

8. The burning system as described in claim 7, wherein the burning module begins writing the programs into the flash memory from the address linked to the first block of the flash memory when the program's size equals to or is greater than the remaining storage capacity of the flash memory.

9. The burning system as described in claim 7, wherein the burning module begins writing programs into the flash memory from the address linked to the first block of the flash memory when the flash memory comprises only one storage sector.
